(19) United States
(12) Patent Application Publication
(10) Pub. No.: US 2020/0101961 A1
(43) Pub. Date: Apr. 2, 2020

(54) SYSTEM AND METHOD FOR INHIBITING HARSH ENGAGEMENT OF A ONE-WAY CLUTCH IN A VEHICLE

(71) Applicant: GM Global Technology Operations LLC, Detroit, MI (US)

(72) Inventor: Young Joo Lee, Rochester, MI (US)

(73) Assignee: GM Global Technology Operations LLC, Detroit, MI (US)

(21) Appl. No.: 16/149,192

(22) Filed: Oct. 2, 2018

(51) Int. Cl. B60W 10/02; B60W 10/08; B60W 50/038

(52) U.S. Cl. CPC B60W 10/026; B60W 20/30; B60W 50/038; B60W 10/08

(57) ABSTRACT

A system according to the present disclosure includes an acceleration limit module and a torque command module. The acceleration limit module is configured to determine whether an acceleration of an electric motor in a vehicle is greater than an acceleration limit having a first nonzero value and generate a first torque reduction request when the motor acceleration is greater than the acceleration limit. The torque command module is configured to determine a torque command for the electric motor based on a driver input, and decrease the torque command in response to the first torque reduction request to reduce harshness associated with engaging a one-way clutch of the vehicle. The one-way clutch couples the electric motor to a wheel of the vehicle when the one-way clutch is engaged.

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to systems and methods for inhibiting harsh engagement of a one-way clutch in a vehicle.

A one-way clutch transfers torque in only one direction. A one-way clutch typically includes a driving member, a driven member, and a connector that connects the driving and driven members to one another to transfer torque from the driving member to the driven member. In one example, the driven member is a first disc, the driving member is a second disc, and the connector is a ratchet mechanism that connects the first and second discs to one another.

One-way clutches are included in a variety of vehicle applications where it is desired to transfer torque in only one direction. In one example, a one-way clutch is included in an electric bike to transfer torque from an electric motor to a chainring in only the direction in which the chainring is rotated (e.g., pedaled) in order to propel the electric bike. In some instances, gear lash or clutch lash in linear or angular distances cause oscillations and undesired fast changes in the speed of the electric motor. These oscillations and undesired fast changes in the speed of the electric motor cause harsh engagement of the one-way clutch, which may cause damage to mechanical parts, such as a clutch connector, and lead to customer dissatisfaction.

### SUMMARY

A first example of a system according to the present disclosure includes an acceleration limit module and a torque command module. The acceleration limit module is configured to determine whether an acceleration of an electric motor in a vehicle is greater than an acceleration limit having a first nonzero value and generate a first torque reduction request when the motor acceleration is greater than the acceleration limit. The torque command module is configured to determine a torque command for the electric motor based on a driver input, and decrease the torque command in response to the first torque reduction request to reduce harshness associated with engaging a one-way clutch of the vehicle. The one-way clutch couples the electric motor to a wheel of the vehicle when the one-way clutch is engaged.

In one example, the torque command indicates an amount of current to be supplied to the electric motor, and the first torque reduction request indicates an amount by which to decrease the amount of current to be supplied to the electric motor.

In one example, the acceleration limit is predetermined based on a balance between a minimum acceptable acceleration of the electric motor and a maximum acceptable harshness associated with engaging the one-way clutch.

In one example, the acceleration limit module is configured to set the first torque reduction request to a second nonzero value when the motor acceleration is greater than the acceleration limit, and set the first torque reduction request to zero when the motor acceleration is less than or equal to the acceleration limit.

In one example, the system further comprises a motor acceleration module configured to determine the motor acceleration based on a speed of the electric motor, and a motor speed module configured to determine the motor speed based on a position of the electric motor.

In one example, the system further comprises a motor position module configured to estimate the motor position based on a voltage supplied to the electric motor and a current supplied to the electric motor.

In one example, the acceleration limit module is configured to generate the first torque reduction request based on a difference between the acceleration limit and the motor acceleration.

In one example, the acceleration limit module is configured to set an error value equal to the difference between the acceleration limit and the motor acceleration, and apply at least one gain to the error value to generate the first torque reduction request.

In one example, the at least one gain includes a proportional gain and an integral gain.

In one example, the system further comprises further comprises an acceleration damping module configured to apply a damping gain to the motor acceleration to generate a second torque reduction request, and the torque command module is configured to decrease the torque command in response to the second torque reduction request.

In one example, the torque command indicates an amount of current to be supplied to the electric motor, and the second torque reduction request indicates an amount by which to decrease the amount of current to be supplied to the electric motor.

In one example, the system further comprises an acceleration filter module configured to apply a band-pass filter to the motor acceleration, and the acceleration damping module is configured to apply the damping gain to the filtered motor acceleration to generate the second torque reduction request.

In one example, the torque command module is configured to decrease the torque command by an amount equal to a sum of the first and second torque reduction requests.

In one example, the damping gain is a proportional gain.

A second example of a system according to the present disclosure includes an acceleration limit module and a torque command module. The acceleration limit module is configured to determine whether an acceleration of an electric motor in a vehicle is greater than an acceleration limit having a nonzero value, and generate a first torque reduction request when the motor acceleration is greater than the acceleration limit. The torque command module is configured to determine a torque command for the electric motor based on a driver input and decrease the torque command in response to the first torque reduction request to reduce harshness associated with engaging a one-way clutch of the vehicle. The one-way clutch couples the electric motor to a wheel of the vehicle when the one-way clutch is engaged. The torque command indicates an amount of current to be supplied to the electric motor. The first torque reduction request indicates an amount by which to decrease the amount of current to be supplied to the electric motor.

In one example, the acceleration limit module is configured to generate the first torque reduction request based on a difference between the acceleration limit and the motor acceleration.

In one example, the system further comprises an acceleration damping module configured to apply a damping gain to the motor acceleration to generate a second torque reduction request, the second torque reduction request indicates an amount by which to decrease the amount of current to be supplied to the electric motor, and the torque command module is configured to decrease the torque command in response to the second torque reduction request.

In one example, the system further comprises an acceleration filter module configured to apply a band-pass filter to the motor acceleration, and the acceleration damping module is configured to apply the damping gain to the filtered motor acceleration to generate the second torque reduction request.

In one example, the torque command module is configured to decrease the torque command by an amount equal to a sum of the first and second torque reduction requests.

An example of a method according to the present disclosure includes determining whether an acceleration of an electric motor in a vehicle is greater than an acceleration limit having a nonzero value, generating a first torque reduction request when the motor acceleration is greater than the acceleration limit, determining a torque command for the electric motor based on a driver input, and decreasing the torque command in response to the first torque reduction request to reduce harshness associated with engaging a one-way clutch of the vehicle. The one-way clutch couples the electric motor to a wheel of the vehicle when the one-way clutch is engaged.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a schematic of an example vehicle according to the principles of the present disclosure;

FIG. 2 is a functional block diagram of an example control system according to the principles of the present disclosure;

FIG. 3 is a flowchart illustrating an example method for reducing harsh engagement of a one-way clutch according to the principles of the present disclosure; and

FIGS. 4 through 6 are graphs illustrating example motor speed signals and torque command signals according to the principles of the present disclosure.

In the drawings, reference numbers may be reused to identify similar and/or identical elements.

### DETAILED DESCRIPTION

A system and method according to the present disclosure inhibits harsh engagement of a one-way clutch in a vehicle by limiting the acceleration of the driving member, and thereby reducing oscillations in the speed of the driving member. The system and method generates a torque command for the driving member based on a driver input and decreases the torque command based on the driving member acceleration in order to limit the driving member acceleration. In one example, the system and method decreases the torque command based on a difference between the driving member acceleration and an acceleration limit. In another example, the system and method applies a band-pass filter to the driving member acceleration and reduces the torque command based on the filtered driving member acceleration. Decreasing the torque command for the driving member as described above reduces oscillations and undesired fast changes in the driving member speed, which inhibits harsh engagement of the one-way clutch.

In an example electric bike, the driving member is an electric motor (and/or a disc connected thereto), the driven member is a chainring (and/or a disc connected thereto), and the one-way clutch transfers torque from the electric motor to the chainring. The system and method generates a torque command for the electric motor based on a driver input such as a pedaling force applied to the chainring. In one example, the system and method generates a first torque reduction request based on a difference between the motor acceleration and the acceleration limit, and decreases the torque command based on the first torque reduction request. In another example, the system and method applies a band-pass filter to the motor acceleration, generates a second torque reduction request based on the filtered motor acceleration, and decreases the torque command based on the second torque reduction request. In another example, the system and method decreases the torque command based on the sum of the first and second torque reduction requests.

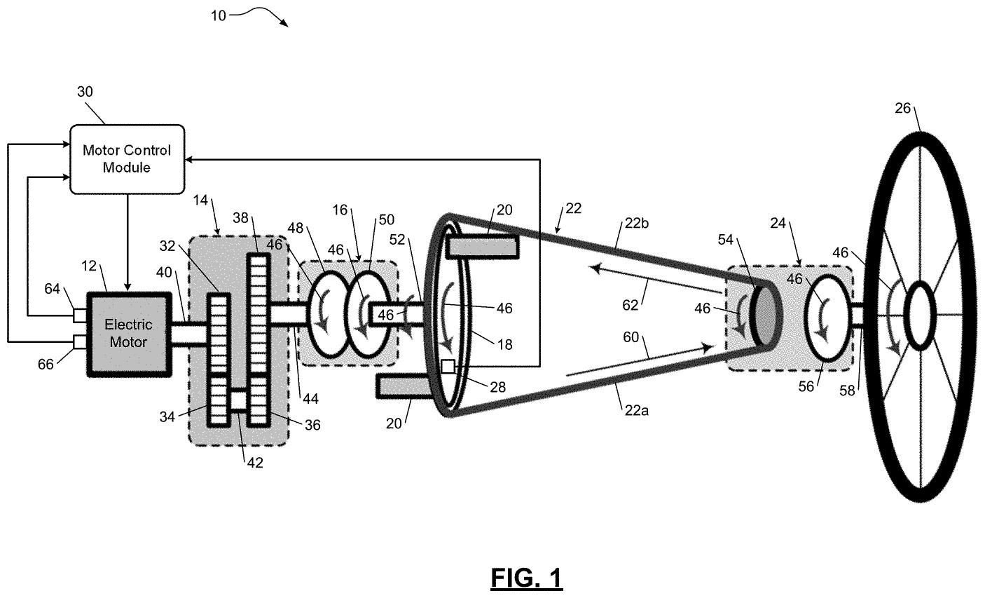

Referring now to FIG. 1, an example of a vehicle 10 according to the present disclosure is an electric bike. The vehicle 10 includes an electric motor 12, a gearbox 14, a one-way clutch 16, a chainring 18, pedals 20, a belt or chain 22, a cassette 24, and a drive wheel 26. Although the vehicle 10 is an electric bike, the teachings of the present disclosure apply to other types of vehicles that include a one-way clutch. For example, the teachings of the present disclosure apply to motorcycles, cars, trucks, and buses that include a one-way clutch.

A driver may propel the vehicle 10 by placing his or her feet on the pedals 20 and rotating the chainring 18 by applying a force to the pedals 20 (i.e., by pedaling). The chainring 18 is coupled to the drive wheel 26 via the chain 22 and the cassette 24. Thus, rotating the chainring 18 causes the drive wheel 26 to rotate, which propels the vehicle 10.

In addition, a torque sensor 28 detects the amount of pedal torque applied to the chainring 18 via the pedals 20, and a motor control module 30 controls the electric motor 12 to produce a motor torque in direct proportion to the pedal torque. The electric motor 12 is coupled to the chainring 18 via the gearbox 14 and the one-way clutch 16. Thus, controlling the electric motor 12 to produce the motor torque increases the amount of torque that is applied to the chainring 18 and transferred to the drive wheel 26, which causes the vehicle 10 to accelerate faster.

The vehicle 10 is described above as being equipped with pedal-assist since the amount of torque produced by the electric motor 12 is regulated by pedaling. Additionally or alternatively, the vehicle 10 may be equipped with power-on demand, in which case the driver may rotate an accelerator grip (not shown) or press an accelerator button (not shown) to cause the electric motor 12 to produce the motor torque. Thus, the vehicle 10 may be propelled by the electric motor 12 alone. Additionally or alternatively, the vehicle 10 may not be equipped with pedal-assist or the driver may disable pedal-assist such that the vehicle 10 may be propelled by pedal power alone (i.e., the vehicle 10 may be fully human-powered).

The gearbox 14 transfers torque from the electric motor 12 to the one-way clutch 16 at one or more gear ratios. The gearbox 14 includes a first gear 32, a second gear 34, a third gear 36, and a fourth gear 38. The diameters of the first, second, third, and fourth gears 32, 34, 36, and 38 affect the gear ratio at which the gearbox 14 transfers torque. In various implementations, the gearbox 14 may include more gears or less gears than the number of gears shown in FIG. 1, and/or the gear ratio at which the gearbox 14 transfers torque may be adjusted by engaging different ones of the gears in the gearbox 14.

The first gear 32 is connected to the electric motor 12 via a motor shaft 40. The second gear 34 includes teeth that meshingly engage with teeth on the first gear 32. The third gear 36 is connected to the second gear 34 via a gear shaft 42. The third gear 36 includes teeth that meshingly engage with teeth on the fourth gear 38. The fourth gear 38 is connected to the one-way clutch 16 via an input shaft 44.

The one-way clutch 16 transfers torque from the electric motor 12 to the chainring 18 in a first direction 46 and does not transfer torque from the electric motor 12 to the chainring 18 in a second direction (not shown) opposite of the first direction. Thus, as its name suggests, the one-way clutch 16 transfers torque from the electric motor 12 to the chainring 18 in only one direction (i.e., only in the first direction 46). The first direction 46 is the direction in which the driver moves the pedals 20 in order to move the vehicle 10 forward.

The one-way clutch 16 includes a first disc 48 and a second disc 50. The first disc 48 is connected to the gearbox 14 via the input shaft 44. The second disc is connected to the chainring 18 via an output shaft 52. The one-way clutch 16 is engaged when the first and second discs 48 and 50 are connected to (e.g., in contact with) one another. The first and second discs 48 and 50 may be connected to one another via a ratchet mechanism (not shown). The ratchet mechanism may allow the first disc 48 to rotate the second disc 50 in the first direction 46 while preventing the first disc 48 from rotating the second disc 50 in the second direction.

The one-way clutch 16 couples the electric motor 12 to the drive wheel 26 when the one-way clutch 16 is engaged. The one-way clutch 16 decouples the electric motor 12 from the drive wheel 26 when the one-way clutch 16 is disengaged. The one-way clutch 16 engages in response to movement of the first or second disc 48 or 50 in the first direction 46. Thus, the one-way clutch 16 engages when the electric motor 12 rotates the first disc 48 in the first direction 46 or when the driver applies a force to the pedals 20 to rotate the second disc 50 in the first direction 46.

The cassette 24 transfer torque from the chainring 18 to the drive wheel 26 at one or more gear ratios. The cassette 24 includes a first sprocket 54 and a second sprocket 56. The first and second sprockets 54 and 56 are connected to and concentrically disposed about a hub 58 of the drive wheel 26. Thus, movement of the first or second sprocket 54 or 56 in the first direction 46 causes movement of the drive wheel 26 in the first direction 46. In various implementations, the cassette 24 may include more sprockets or less sprockets than the number of sprockets shown in FIG. 1, and/or the gear ratio at which the cassette 24 transfers torque may be adjusted by engaging different ones of the sprockets in the cassette 24.

The chain 22 includes a first chain section 22a and a second chain section 22b. Rotation of the chainring 18 in the first direction 46 causes the first chain section 22a to move in a third direction 60 and causes the second chain section 22b to move in a fourth direction 62. Movement of the first and second chain sections 22a and 22b in the third and fourth directions 60 and 62, respectively, causes the first sprocket 54 to rotate in the first direction 46.

The motor control module 30 controls the amount of torque produced by the electric motor 12. The motor control module 30 accomplishes this at least on part by generating a torque command. The motor control module 30 generates the torque command based on a driver input such as a pedal torque level detected by the torque sensor 28, a position of the accelerator grip, and/or a state of the accelerator button (e.g., pressed or not pressed). The motor control module 30 may either output the torque command to the electric motor 12 or adjust the amount of current supplied to the electric motor 12 to satisfy the torque command. The motor control module 30 may determine the amount of current needed by the electric motor 12 to satisfy the torque command using a lookup table.

To reduce harshness associated with engaging the one-way clutch 16, the motor control module 30 also determines the acceleration of the electric motor 12 and reduces the torque command when the motor acceleration is greater than an acceleration limit (e.g., a nonzero value). In one example, the motor control module 30 generates a first torque reduction request based on a difference between the motor acceleration and the acceleration limit, and decreases the torque command based on the first torque reduction request. To reduce the amount of alternating content (AC) acceleration or oscillatory acceleration, the motor control module 30 may apply a band-pass filter to the motor acceleration, and reduce the torque command based on the filtered motor acceleration. In one example, the motor control module 30 applies a damping gain to the filtered motor acceleration to generate a second torque reduction request, and decreases the torque command based on the sum of the first and second torque reduction requests.

The motor control module 30 may determine the motor acceleration by determining the second derivative of the position of the electric motor 12 with respect to time. The motor position may be measured or estimated. The motor control module 30 may estimate the motor position based on the amount of voltage supplied to the electric motor 12 and the amount of current supplied to the electric motor 12. The amount of voltage supplied to the electric motor 12 may be measured using a voltage sensor 64. Additionally or alternatively, the motor control module 30 may estimate the amount of voltage supplied to the electric motor 12 based on, for example, a measured voltage of a battery (not shown) that supplies power to the electric motor 12 and a duty cycle of a pulse width modulated (PWM) control signal sent to the electric motor 12 by the motor control module 30. For example, the motor control module 30 may estimate the amount of voltage supplied to the electric motor 12 using a function or mapping that relates battery voltage and motor duty cycle to motor voltage. The amount of current supplied to the electric motor 12 may be measured using a current sensor 66.

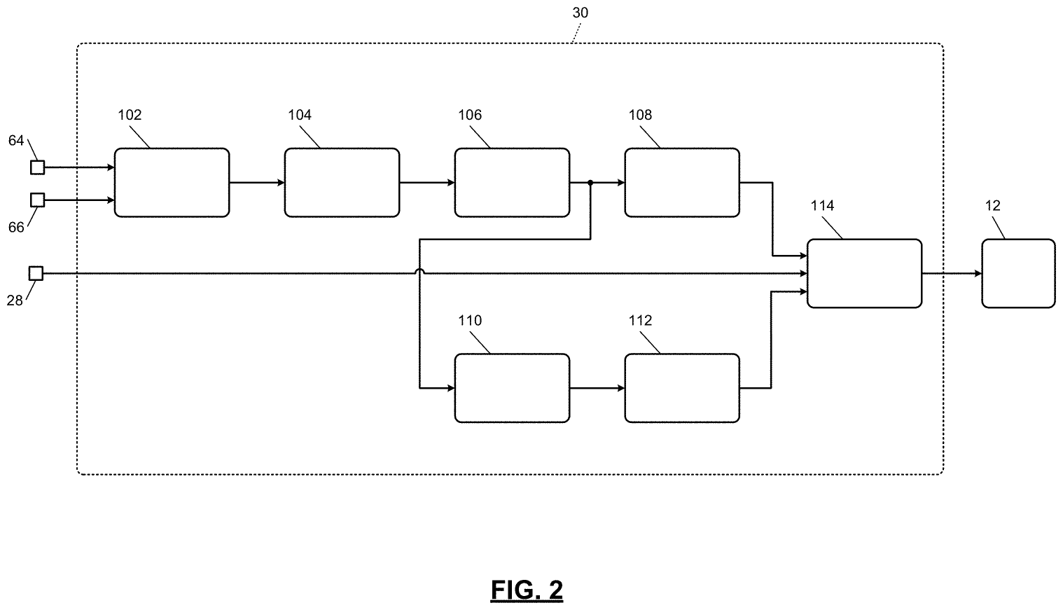

Referring now to FIG. 2, an example implementation of the motor control module 30 includes a motor position module 102, a motor speed module 104, a motor acceleration module 106, and an acceleration limit module 108. The motor position module 102 determines the position of the electric motor 12 (e.g., the position of the motor shaft 40) and outputs the motor position. The motor position module 102 may determine the motor position based on the amount of current supplied to the electric motor 12 from the current sensor 66 and either the amount of voltage supplied to the electric motor 12 from the voltage sensor 64 or the estimated motor voltage. The motor position module 102 may determine the motor position based on the motor voltage and the motor current using a function or mapping that relates motor voltage and motor current to motor position.

The motor speed module 104 determines the speed of the electric motor 12 based on the motor position. In one example, the motor speed module 104 determines a first derivative of the motor position with respect to time in order to obtain the motor speed. The motor acceleration module 106 determines the acceleration of the electric motor 12 based on the motor speed. In one example, motor acceleration module determines a first derivative of the motor speed with respect to time in order to obtain the motor acceleration.

The acceleration limit module 108 determines whether the motor acceleration is greater than the acceleration limit and generates a first torque reduction request when the motor acceleration is greater than the acceleration limit. The acceleration limit module 108 may set torque reduction request equal to a nonzero value when the motor acceleration is greater than the acceleration limit. The acceleration limit module 108 may set the first torque reduction request equal to zero when the motor acceleration is less than or equal to the acceleration limit. The acceleration limit module 108 outputs the first torque reduction request.

The acceleration limit may be predetermined through calibration based on a balance between a minimum acceptable acceleration of the electric motor 12 and a maximum acceptable harshness associated with engaging the one-way clutch 16. For example, the accelerator limit may initially be set to the minimum acceptable acceleration and the harshness may be observed while engaging the one-way clutch 16. If the harshness is less than the maximum acceptable harshness, the accelerator limit may be increased and the harshness may be observed while engaging the one-way clutch 16. This process may be repeated until the harshness is equal to the maximum acceptable harshness.

The amount of force applied to the first or second disc 48 or 50 may be measured using a load sensor and used as an indicator of harshness. Additionally or alternatively, the frequency and/or magnitude of oscillations in the motor speed may be used as an indicator of harshness. Thus, the maximum acceptable harshness may be expressed as a force, a frequency, and/or a speed.

The acceleration limit module 108 may determine the first torque reduction request based on the difference between the motor acceleration and the acceleration limit. In one example, the acceleration limit module 108 sets an error value equal to the difference between the motor acceleration and the acceleration limit, and applies one or more gains to the error value to generate the first torque reduction request. The acceleration limit module 108 outputs the first torque reduction request.

The acceleration limit module 108 may apply a proportional gain and/or an integral gain to the error value to generate the first torque reduction request. For example, the acceleration limit module 108 may generate the first torque reduction request using a relationship such as

TR₁=Kₚe(t)+∫₀^{t}Kᵢe(t)dτ, (1)

where TR₁ is the first torque reduction request, Kₚ is the proportional gain, e(t) is the error value, Kᵢ is the integral gain, and t and τ are variables representing time.

The example implementation of the motor control module 30 shown in FIG. 2 further includes an acceleration filter module 110, an acceleration damping module 112, and a torque command module 114. The acceleration filter module 110 applies a band-pass filter to the motor acceleration and outputs the filtered motor acceleration. The band-pass filter is defined by an upper frequency (e.g., 20 Hertz (Hz)) and a lower frequency (e.g., 10 Hz). The upper and lower frequencies may be predetermined by observing the frequency content of oscillations in the motor speed having the highest magnitude. For example, the upper and lower frequencies may be set to upper and lower values of a frequency range associated with oscillations in the motor speed having magnitudes greater than a predetermined value. Alternatively, the frequency range may be associated with oscillations in the motor speed having magnitudes greater than a predetermined percentage of the magnitudes of all of the oscillations in the motor speed during the observation period.

The acceleration damping module 112 generates a second torque reduction request by applying a damping gain to the filtered motor acceleration. For example, the acceleration damping module 112 may set the second torque reduction request equal to a product of the damping gain and the filtered motor acceleration. The damping gain may be a proportional gain. The acceleration damping module 112 outputs the second torque reduction request.

The torque command module 114 generates the torque command based on the pedal torque level from the torque sensor 28. The torque command module 114 adjusts the torque command in direct proportion to the pedal torque level. Thus, the torque command module 114 increases the torque command as the pedal torque level increases and vice versa. The torque command module 114 may determine the torque command using a function or mapping that relates pedal torque level to torque command.

After generating the torque command based on the pedal torque level, the torque command module 114 decreases the torque command based on the sum of the first and second torque reduction requests. For example, if the torque command is greater than the sum of the first and second torque reduction requests, the torque command 114 decreases the torque command by an amount equal to the sum of the first and second torque reduction requests. Conversely, if the torque command is less than the sum of the first and second torque reduction requests, the torque command 114 sets the torque command equal to zero. The torque command module 114 outputs the reduced torque command to the electric motor 12.

The torque command may indicate an amount of current to be supplied to the electric motor 12, and each of the first and second torque reduction requests may indicate an amount by which to decrease the amount of current to be supplied to the electric motor 12. Thus, the gains applied by the acceleration limit module 108 and the acceleration damping module 112 may convert acceleration values into current values. For example, the unit of the gains may be amperes (A) per revolution per minute (rpm) per second squared (s²), or A/(rpm/s).

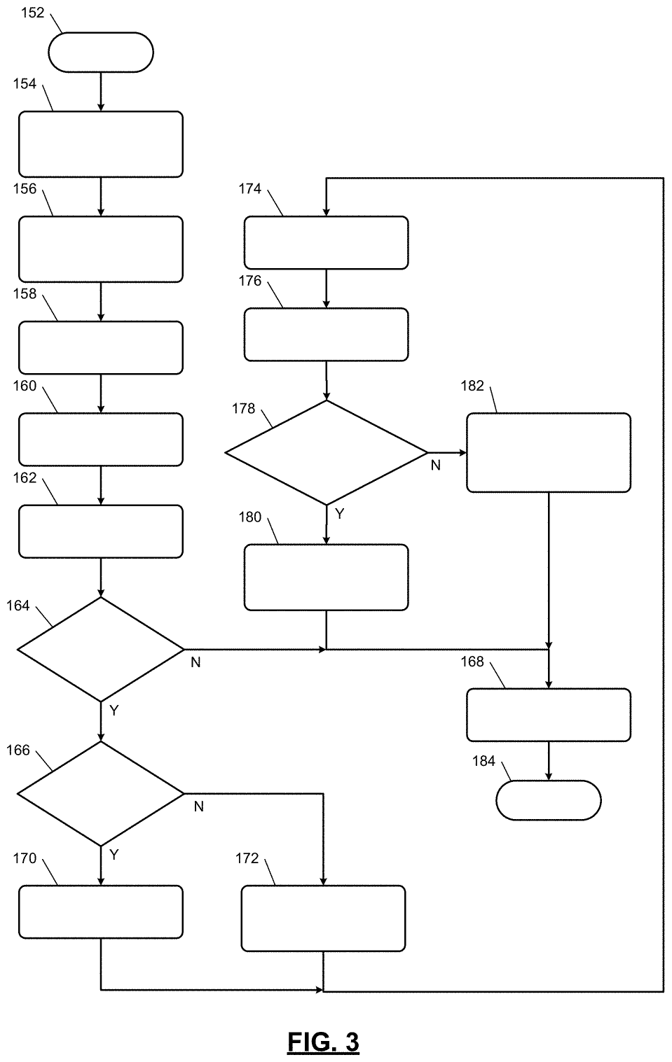

Referring now to FIG. 3, an example method for reducing harsh engagement of the one-way clutch 16 begins at 152. The method is described in the context of the modules of FIG. 2. However, the particular modules that perform the steps of the method may be different than the modules mentioned below, or the method may be implemented apart from the modules of FIG. 2.

At 154, the torque command module 114 generates a torque command based on a driver input such as a pedal torque level detected by the torque sensor 28, a position of the accelerator grip, and/or a state of the accelerator button. At 156, the voltage sensor 64 measures the voltage supplied to the electric motor 12, and the current sensor 66 measures the current supplied to the electric motor 12. Instead of measuring the voltage supplied to the electric motor 12, the motor control module 30 may estimate the voltage supplied to the electric motor 12 as discussed above in order to eliminate measurement noise.

At 158, the motor control module 30 estimates the position of the electric motor 12 based on the amount of voltage supplied to the electric motor 12 and the amount of current supplied to the electric motor 12. At 160, the motor speed module 104 determines the speed of the electric motor 12 based on the motor position. At 162, the motor acceleration module 106 determines the acceleration of the electric motor 12 based on the motor speed.

At 164, the torque command module 114 determines whether the one-way clutch 16 is engaging. If the one-way clutch 16 is engaging, the method continues at 166. Otherwise, the method continues at 168.

At 166 through 182, the torque command module 114 generates the first and second torque reduction requests and decreases the torque command based on the sum of the first and second torque reduction requests. Thus, the torque command module 114 decreases the torque command based on one of the first and second torque reduction requests when one-way clutch 16 is engaging. Conversely, the torque command module 114 does not decrease the torque command based on the first or second torque reduction request when the one-way clutch 16 is not engaging (e.g., when the one-way clutch 16 is disengaged or fully engaged). In various implementations, 164 may be omitted, and the method may continue directly from 162 to 166. In these implementations, the torque command module 114 may decrease the torque command based on one of the first and second torque reduction requests regardless of whether the one-way clutch 16 is engaging.

In one example, the ratchet mechanism may rotatably couple the first and second discs 48 and 50, and thereby engage the one-way clutch 16, when the speeds of the first and second discs 48 and 50 are equal to one another. In this example, the vehicle 10 may include sensors (not shown) that measure the speeds of the first and second discs 48 and 50, and the torque command module 114 may determine that the one-way clutch 16 is engaging when the speeds of the first and second discs 48 and 50 are within a predetermined range of one another and/or are different than one another. In various implementations, engagement of the one-way clutch 16 may be electronically controlled by a clutch control module (not shown), and the torque command module 114 may determine whether the one-way clutch 16 is engaging based on an input from the clutch control module.

At 166, the acceleration limit module 108 determines whether the motor acceleration is greater than the acceleration limit. If the motor acceleration is greater than the acceleration limit, the method continues at 170. Otherwise, the method continues at 172. At 170, the acceleration limit module 108 generates the first torque reduction request using, for example, relationship (1). At 172, the acceleration limit module 108 sets the first torque reduction request equal to zero.

At 174, the acceleration filter module 110 applies the band-pass filter to the motor acceleration. At 176, the acceleration damping module 112 generates the second torque reduction request based on the filtered motor acceleration. For example, the acceleration damping module 112 may generate the second torque reduction request by applying the damping gain to the filtered motor acceleration.

At 178, the torque command module 114 determines whether the torque command is greater than the sum of the first and second torque reduction requests. If the torque command is greater than the sum of the first and second torque reduction requests, the method continues at 180. Otherwise, the method continues at 182. At 180, the torque command module 114 decreases the torque command by an amount equal to the sum of the first and second torque reduction requests. At 182, the torque command module 114 sets the torque command equal to zero.

At 168, the torque command module 114 outputs the torque command to the electric motor 12. Alternatively, the torque command module 114 may adjust the amount of current supplied to the electric motor 12 to satisfy the torque command. The method ends at 184.

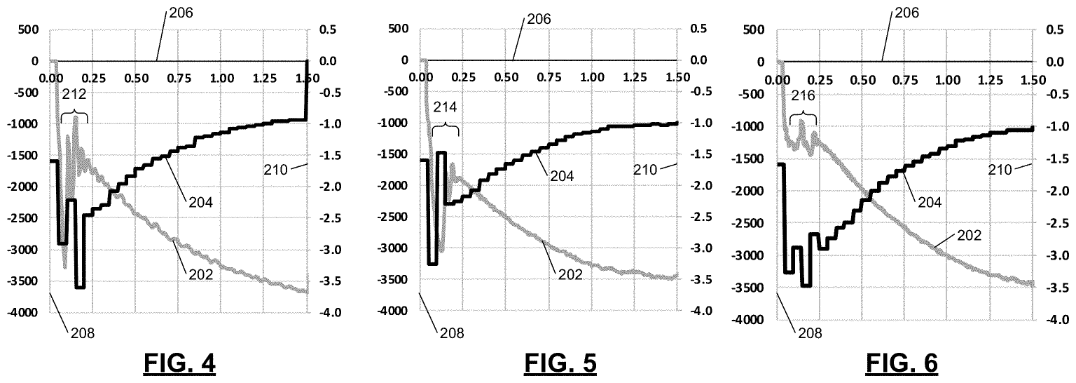

Referring now to FIGS. 4 through 6, a motor speed signal 202 and a torque command signal 204 are plotted with respect to an x-axis 206 that represents time in seconds, a first y-axis 208 that represents rotational speed in revolutions per minute, and a second y-axis 210 that represents torque in Newton-meters (Nm). The motor speed signal 202 indicates the speed of the electric motor 12. The torque command signal 204 indicates the torque command that is output by the torque command module 114.

In FIG. 4, the torque command is not reduced by the first or second torque reduction requests. Thus, at 212, there are several high-magnitude oscillations in the motor speed that may cause a harsh engagement of the one-way clutch 16. In FIG. 5, the torque command is reduced by the second torque reduction request but not the first torque reduction request. Thus, at 214, there are high-magnitude oscillations in the motor speed, but the number and magnitudes of the oscillations are less than the number and magnitudes of the oscillations shown at 212 of FIG. 4.

In FIG. 6, the torque command is reduced by of the sum of the first and second torque reduction requests. At 216, there are oscillations in the motor speed, but the magnitudes of the oscillations are significantly less than the magnitudes of the oscillations shown at 212 of FIG. 4 and the magnitudes of the oscillations shown at 214 of FIG. 5. Thus, the magnitudes of the oscillations at 216 are not likely to cause a harsh engagement of the one-way clutch 16.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A system comprising:
an acceleration limit module configured to:
determine whether an acceleration of an electric motor in a vehicle is greater than an acceleration limit having a first nonzero value; and
generate a first torque reduction request when the motor acceleration is greater than the acceleration limit; and
a torque command module configured to:
determine a torque command for the electric motor based on a driver input; and
decrease the torque command in response to the first torque reduction request to reduce harshness associated with engaging a one-way clutch of the vehicle, wherein the one-way clutch couples the electric motor to a wheel of the vehicle when the one-way clutch is engaged.

2. The system of claim 1 wherein:
the torque command indicates an amount of current to be supplied to the electric motor; and
the first torque reduction request indicates an amount by which to decrease the amount of current to be supplied to the electric motor.

3. The system of claim 1 wherein the acceleration limit is predetermined based on a balance between a minimum acceptable acceleration of the electric motor and a maximum acceptable harshness associated with engaging the one-way clutch.

4. The system of claim 1 wherein the acceleration limit module is configured to:
set the first torque reduction request to a second nonzero value when the motor acceleration is greater than the acceleration limit; and
set the first torque reduction request to zero when the motor acceleration is less than or equal to the acceleration limit.

5. The system of claim 1 further comprising:
a motor acceleration module configured to determine the motor acceleration based on a speed of the electric motor; and
a motor speed module configured to determine the motor speed based on a position of the electric motor.

6. The system of claim 5 further comprising a motor position module configured to estimate the motor position based on a voltage supplied to the electric motor and a current supplied to the electric motor.

7. The system of claim 1 wherein the acceleration limit module is configured to generate the first torque reduction request based on a difference between the acceleration limit and the motor acceleration.

8. The system of claim 7 wherein the acceleration limit module is configured to:
set an error value equal to the difference between the acceleration limit and the motor acceleration; and
apply at least one gain to the error value to generate the first torque reduction request.

9. The system of claim 8 wherein the at least one gain includes a proportional gain and an integral gain.

10. The system of claim 1 further comprising an acceleration damping module configured to apply a damping gain to the motor acceleration to generate a second torque reduction request, wherein the torque command module is configured to decrease the torque command in response to the second torque reduction request.

11. The system of claim 10 wherein:
the torque command indicates an amount of current to be supplied to the electric motor; and
the second torque reduction request indicates an amount by which to decrease the amount of current to be supplied to the electric motor.

12. The system of claim 11 further comprising an acceleration filter module configured to apply a band-pass filter to the motor acceleration, wherein the acceleration damping module is configured to apply the damping gain to the filtered motor acceleration to generate the second torque reduction request.

13. The system of claim 10 wherein the torque command module is configured to decrease the torque command by an amount equal to a sum of the first and second torque reduction requests.

14. The system of claim 10 wherein the damping gain is a proportional gain.

15. A system comprising:
an acceleration limit module configured to:
determine whether an acceleration of an electric motor in a vehicle is greater than an acceleration limit having a nonzero value; and
generate a first torque reduction request when the motor acceleration is greater than the acceleration limit; and
a torque command module configured to:
determine a torque command for the electric motor based on a driver input; and
decrease the torque command in response to the first torque reduction request to reduce harshness associated with engaging a one-way clutch of the vehicle,
wherein:
the one-way clutch couples the electric motor to a wheel of the vehicle when the one-way clutch is engaged;
the torque command indicates an amount of current to be supplied to the electric motor; and
the first torque reduction request indicates an amount by which to decrease the amount of current to be supplied to the electric motor.

16. The system of claim 15 wherein the acceleration limit module is configured to generate the first torque reduction request based on a difference between the acceleration limit and the motor acceleration.

17. The system of claim 15 further comprising an acceleration damping module configured to apply a damping gain to the motor acceleration to generate a second torque reduction request, wherein the second torque reduction request indicates an amount by which to decrease the amount of current to be supplied to the electric motor, and the torque command module is configured to decrease the torque command in response to the second torque reduction request.

18. The system of claim 17 further comprising an acceleration filter module configured to apply a band-pass filter to the motor acceleration, wherein the acceleration damping module is configured to apply the damping gain to the filtered motor acceleration to generate the second torque reduction request.

19. The system of claim 17 wherein the torque command module is configured to decrease the torque command by an amount equal to a sum of the first and second torque reduction requests.

20. A method comprising:
determining whether an acceleration of an electric motor in a vehicle is greater than an acceleration limit having a nonzero value;
generating a first torque reduction request when the motor acceleration is greater than the acceleration limit;
determining a torque command for the electric motor based on a driver input; and
decreasing the torque command in response to the first torque reduction request to reduce harshness associated with engaging a one-way clutch of the vehicle, wherein the one-way clutch couples the electric motor to a wheel of the vehicle when the one-way clutch is engaged.
